(19) United States
(12) Patent Application Publication
(10) Pub. No.: US 2026/0098435 A1
(43) Pub. Date: Apr. 9, 2026

(54) BIDIRECTIONAL REACTIVE BUMPER SYSTEM FOR TAILGATE

(71) Applicant: Ford Global Technologies, LLC, Dearborn, MI (US)

(72) Inventors: Joseph Prior, Detroit, MI (US); Joshua Robert Hemphill, White Lake, MI (US); Michael Shawn Watterworth, Brighton, MI (US)

(21) Appl. No.: 18/908,940

(22) Filed: Oct. 8, 2024

(51) Int. Cl. E05F 7/04; B62D 33/027

(52) U.S. Cl. CPC E05F 7/04; B62D 33/027

(57) ABSTRACT

A bidirectional bumper assembly comprises a first arm having a pivotal attachment interface associated with a vehicle box structure, and a second arm coupled to the first arm. A first bumper is associated with the first arm, the first bumper comprising a first tailgate abutment surface, and a second bumper is associated with the second arm, the second bumper comprising a second tailgate abutment surface.

### TECHNICAL FIELD

This disclosure relates generally to a bidirectional reactive bumper system, and more specifically to a system with an arm assembly where arms and associated bumper pads act in compression on forward and side surfaces of a tailgate.

### BACKGROUND

Vehicles may include a tailgate that is moveable between a closed position and an open position to allow access to a cargo area. Noise and vibration issues may occur during closing operations.

### SUMMARY

An assembly according to an exemplary aspect of the present disclosure includes, among other things: a first arm including a pivotal attachment interface associated with a vehicle box structure; a second arm coupled to the first arm; a first bumper associated with the first arm, the first bumper comprising a first tailgate abutment surface; and a second bumper associated with the second arm, the second bumper comprising a second tailgate abutment surface.

In a further non-limiting embodiment of any assembly, the assembly includes a base with a box attachment interface, the first arm and the second arm being pivotally attached to the base via the pivotal attachment interface.

In a further non-limiting embodiment of any assembly, the first arm and the second arm rotate as unit about a center axis defined by the pivotal attachment interface.

In a further non-limiting embodiment of any assembly, the unit is in a first position when a tailgate associated with the vehicle box structure is in an open position and wherein the unit is in a second position when the tailgate is in a closed position, and including at least one resilient member that biases the unit toward the first position.

In a further non-limiting embodiment of any assembly, the first tailgate abutment surface is engageable with a forward facing tailgate surface and the second tailgate abutment surface is engageable with a side facing tailgate surface when in a tailgate closed position.

In a further non-limiting embodiment of any assembly, the first bumper and the second bumper are separate from each other and independently compressible from each other.

In a further non-limiting embodiment of any assembly, one of the first arm and the second arm is longer than the other of the first arm and the second arm.

An apparatus according to an exemplary aspect of the present disclosure includes, among other things: a vehicle box structure; a tailgate moveable relative to the vehicle box structure between an open position and a closed position, wherein the tailgate includes a first surface and a second surface that extends transversely relative to the first surface; and at least one bumper assembly comprising: a first arm coupled to a second arm via a pivotal attachment interface, wherein the pivotal attachment interface is associated with the vehicle box structure; a first bumper associated with the first arm, the first bumper engageable with the first surface; and a second bumper associated with the second arm, the second bumper engageable with the second surface.

In a further non-limiting embodiment of any apparatus, the apparatus includes a base plate with an attachment interface to attach to the vehicle box structure and including a pair of pivot mount arms that interface with the pivotal attachment interface.

In a further non-limiting embodiment of any apparatus, the first arm and the second arm rotate as unit about a center axis defined by the pivotal attachment interface.

In a further non-limiting embodiment of any apparatus, the at least one bumper assembly includes at least one resilient member that biases the first arm and the second arm toward the open position.

In a further non-limiting embodiment of any apparatus, the first surface of the tailgate comprises a forward facing tailgate surface and the second surface of the tailgate comprises an edge surface when in the closed position.

In a further non-limiting embodiment of any apparatus, the first bumper and the second bumper are separate from each other and independently compressible from each other in response to input loads from the forward facing tailgate surface and the edge surface.

In a further non-limiting embodiment of any apparatus, the first arm extends in a lateral direction along a vehicle width and the second arm extends in a longitudinal direction along a vehicle length when in the closed position.

In a further non-limiting embodiment of any apparatus, one of the first arm and the second arm is longer than the other of the first arm and the second arm.

In a further non-limiting embodiment of any apparatus, outward facing surfaces of the first bumper and the second bumper includes a plurality of discrete ribs.

A method according to an exemplary aspect of the present disclosure includes, among other things: pivotally attaching a bumper assembly to a vehicle box structure, the bumper assembly comprising a first bumper arm coupled to a second bumper arm; and independently compressing a first bumper on the first bumper arm from a second bumper on the second bumper arm in response to input loads from a first tailgate surface and a second tailgate surface different from the first tailgate surface.

In a further non-limiting embodiment of any method, the method includes mounting a tailgate for pivotal movement relative to the vehicle box structure between an open position and a closed position, and wherein the first tailgate surface comprises a forward facing tailgate surface and the second tailgate surface comprises an edge tailgate surface when in the closed position.

In a further non-limiting embodiment of any method, the bumper assembly is in a first position when the tailgate is in the open position and is in a second position when the tailgate is in the closed position, and the method includes biasing the bumper assembly toward the first position.

In a further non-limiting embodiment of any method, a shaft connects the first bumper arm and the second bumper arm together, and the method includes pivoting the first bumper arm and the second bumper arm together as a unit about a pivot axis defined by the shaft.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle cargo area with a tailgate in a closed position.

FIG. 2 is similar to FIG. 1 but shows a tailgate in an open position and shows a bidirectional reactive bumper arm assembly.

FIG. 3 is an exploded view of the bidirectional reactive bumper arm assembly of FIG. 2.

FIG. 4 is an enlarged view of the detail of the bidirectional reactive bumper arm assembly identified in FIG. 2.

FIG. 5 is a top perspective view of the bidirectional reactive bumper arm assembly of FIG. 4 with the tailgate in the closed position.

FIG. 6A is similar to FIG. 5 but shows the tailgate 15 mm from a fully closed position.

FIG. 6B is similar to FIG. 6A but shows the tailgate 10 mm from a fully closed position.

FIG. 6C is similar to FIG. 6A but shows the tailgate 3 mm from a fully closed position.

FIG. 7 is similar to FIG. 5 but shows another example of a bidirectional reactive bumper arm assembly.

### DETAILED DESCRIPTION

Some tailgate systems are becoming more complex and heavier as they include more features as compared to traditional configurations. In certain conditions, tailgates may experience increased lateral and fore/aft loading, and managing these loads are important for maintaining the structural integrity and NVH performance of the system. The subject disclosure provides a robust bumper system that satisfies these requirements. In implementations, a bidirectional reactive bumper system is provided where arms and associated bumper pads independently react in compression in response to input loads associated with forward facing and side surfaces of a tailgate.

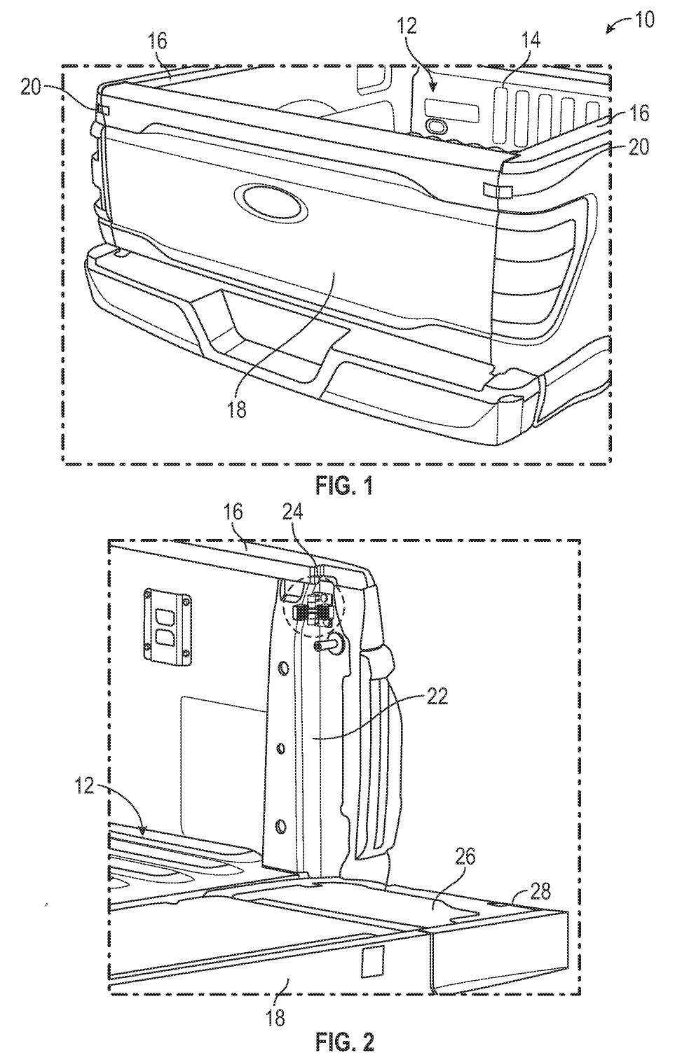

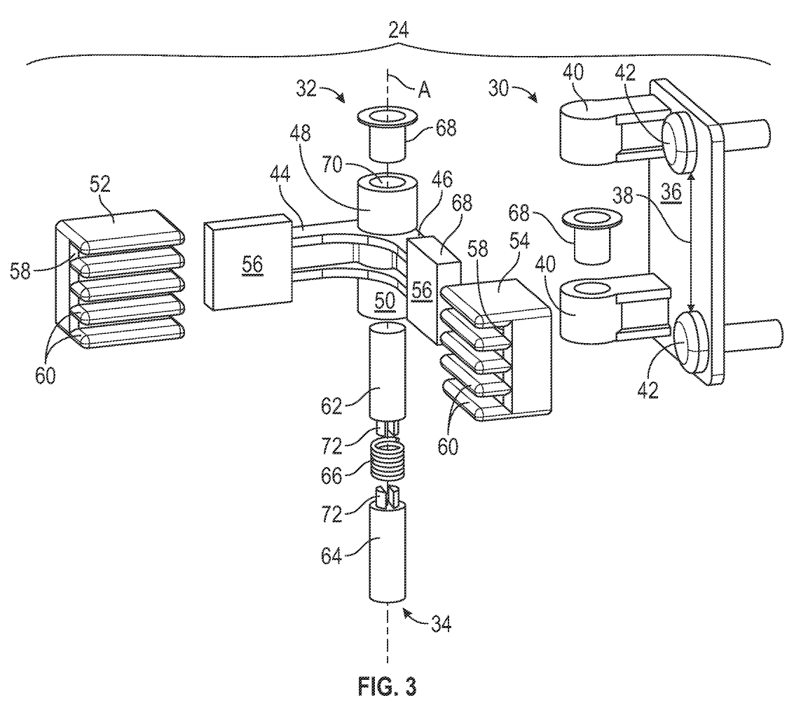

FIG. 1 shows a vehicle 10 having a cargo area 12 that is enclosed by a front wall 14, side walls 16, and a tailgate 18 at one end of the cargo area 12. The tailgate 18 is moveable relative to the side walls 16 between a closed position (FIG. 1) and an open position (FIG. 2).

In implementations, the tailgate 18 includes closure assemblies, schematically shown at 20 in FIG. 1, which are used to secure each end of the tailgate to a box structure 22, e.g. frame member, in the closed position. Any type of closure mechanism can be installed for this purpose. In one example, a closure assembly may comprise a closure associated with one of the tailgate and a box structure and a striker associated with the other of the tailgate and box structure; however, other types of closure assemblies may also be used.

In implementations, a bidirectional reactive bumper assembly 24 (FIG. 2) is associated with the box structure 22 at each side wall 16 (only one is shown in FIG. 2). It should be understood that the bidirectional reactive bumper assembly 24 would be the same for the opposite side wall 16. The bumper assemblies 24 on the left and right sides of the tailgate 18 work together to damp movement between the tailgate and the box structure. In implementations, this bidirectional reactive bumper system accommodates tailgate chucking motion, in any direction, to quickly and effectively damp movement. For example, tailgate movement in a forward direction will activate both bumpers to apply lateral loads to quickly damp movement, while tailgate movement in a lateral direction will activate the bumpers to apply a fore/aft load to damp movement.

In one example, the tailgate 18 includes a first surface 26 and a second surface 28 that extends transversely relative to the first surface 26. In implementations, the first surface 26 comprises an upwardly facing surface when the tailgate 18 is open, and comprises a forward facing surface when the tailgate 18 is closed. In implementations, the second surface 28 comprises a side edge surface of the tailgate 18.

In implementations, the bidirectional reactive bumper assembly 24 includes a base subsystem 30, an arm subsystem 32, and a pivot subsystem 34. In one example, the base subsystem 30 includes a base plate 36 with an attachment interface 38 to attach to the box structure 22 and a pair of pivot mount arms 40 that interface with the pivot subsystem 34.

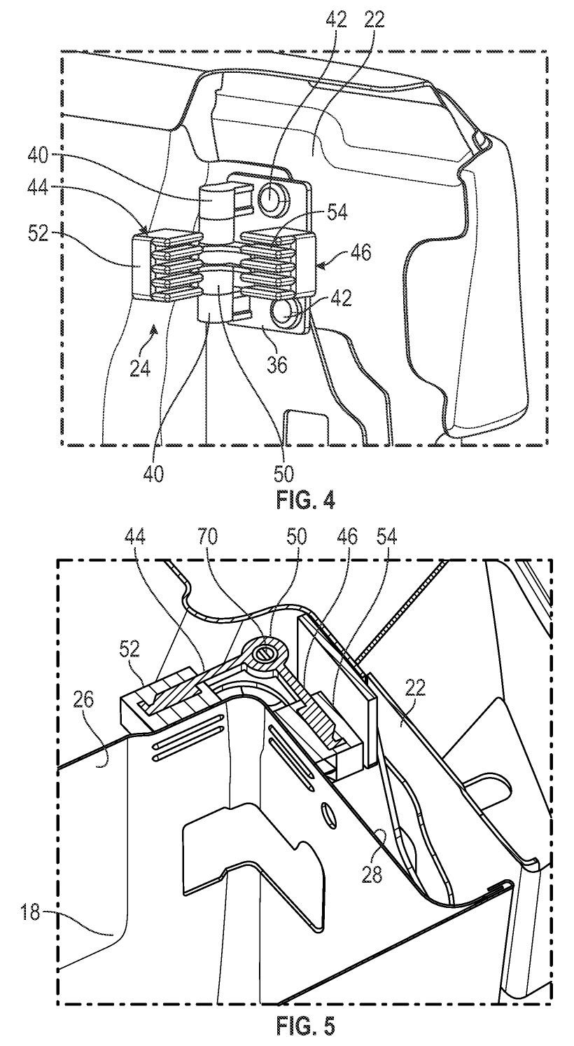

In one example, the base plate 36 comprises a flat rigid structure that is attached to an inward facing surface of the box structure 22. In one example, the attachment interface 38 comprises one or more openings formed in the base plate 36 that receive one or more fasteners 42 as shown in FIG. 4; however, other types of attachment interfaces could also be used.

In one example, the arm subsystem 32 includes a first arm 44 coupled to a second arm 46 via a pivotal attachment interface 48, wherein the pivotal attachment interface 48 is coupled to the vehicle box structure 22 via the pivot mount arms 40 and the pivot subsystem 34. In implementations, a shaft body 50 provides the pivotal attachment interface 48 that connects the first arm 44 and the second arm 46 together. In implementations, the first arm 44 and the second arm 46 pivot together as a unit about a pivot axis A defined by the shaft body 50.

In implementations, the first arm 44 extends in a lateral direction along a vehicle width and the second arm 46 extends in a longitudinal direction along a vehicle length when in the closed position as shown in FIG. 5.

In one example, the arm subsystem 32 further includes a first bumper 52 associated with the first arm 44 and a second bumper 54 associated with the second arm 46. In implementations, the first bumper 52 is engageable with the first surface 26 of the tailgate 18 and the second bumper 54 is engageable with the second surface 28.

In implementations, each arm 44, 46 has one end connected to the shaft body 50 and a distal end that supports the associated bumper 52, 54. In one example, the distal ends comprise enlarged flat pad portions 56 that support the bumpers 52, 54.

In implementations, the bumpers 52, 54 are pads that are comprised of a rubber type material, for example an ethylene-propylene diene monomer (EPDM) material, which is a durable and versatile M-class synthetic rubber. Other similar types of material may also be used. In implementations, the bumper pads 52, 54 can be assembled or overmolded onto the flat pad portions 56 of the arms 44, 46.

In one example, outward facing surfaces 58 of the first bumper 52 and the second bumper 54 include a plurality of discrete ridges or ribs 60. In implementations, the ribs 60 are spaced apart from each other by gaps. In one example, the ribs 60 are generally parallel to each other and extend across an entirety of the outward facing surfaces 58. The ribs 60 further facilitate damping of movement.

In one example, the pivot subsystem 34 includes an upper pivot 62, a lower pivot 64, at least one resilient member 66, and bushings 68. In implementations, the shaft body 50 comprises a cylindrical member with a center bore 70 extending from one end to an opposite end. The upper pivot 62 is associated with an upper end of the bore 70 and the lower pivot 64 is associated with a lower end of the bore 70.

In implementations, each pivot 62, 64 includes a knurled end to secure to the pivot mount arms 40 of the base plate 36.

In implementations, each pivot 62, 64 includes a forked portion 72 to constrain the resilient member 66, e.g., coil spring.

In implementations, the bushings 68 further facilitate the pivoting attachment interface and are associated with the bore 70 of the shaft body 50 and the pivot mount arms 40.

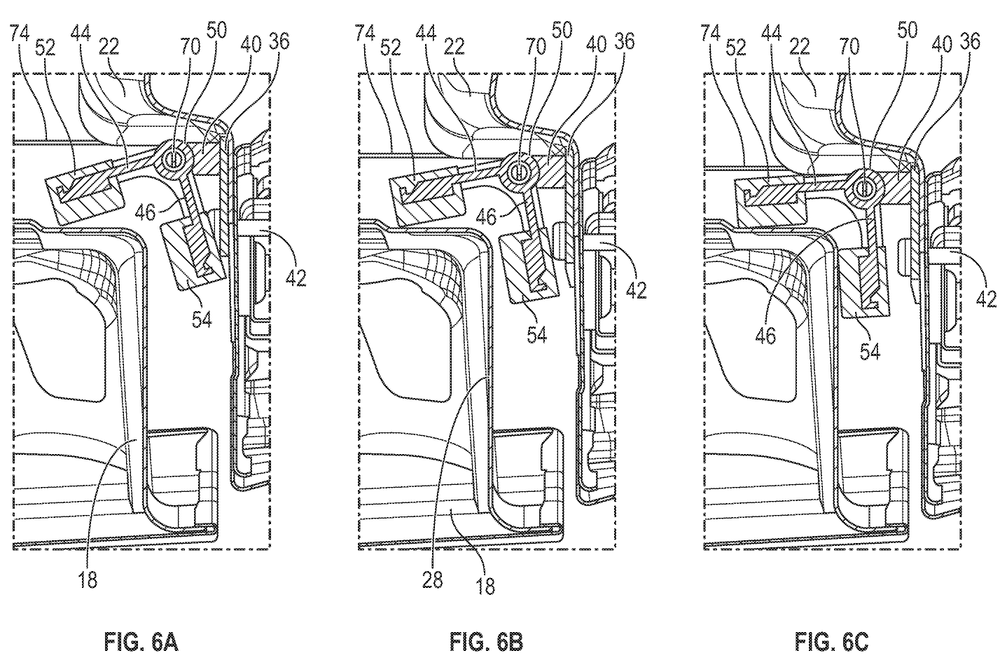

In implementations, the unit comprising the arms 44, 46 and bumpers 52, 54 is in a first position when the tailgate 18 is in the open position and the unit is in a second position when the tailgate 18 is in the closed position. In one example, the resilient member 66 biases the unit toward the first position, e.g. a tailgate open position. This is best shown in FIG. 6A.

FIG. 6A shows the tailgate 18 at a location that is 15 mm from a fully closed position and the bumper assembly 24 biased toward the tailgate open position, e.g. biased in a CCW direction about axis A. As the tailgate 18 approaches the closed position, the forward facing surface 26 makes first contact with the first arm 44/first bumper 52 of the bumper assembly 24. This contact rotates the bumper assembly 24 in a CW direction about the axis A such that the first bumper pad 52 begins to compress between the surface 26 and box surface 74 as shown in FIG. 6B.

FIG. 6B is similar to FIG. 6A but shows the tailgate at a location that is 10 mm from a fully closed position. As the tailgate 18 further approaches the closed position, the bumper assembly 24 continues to rotate about the axis A until the second arm 46/second bumper pad 54 makes contact with the tailgate side surface 28 as shown in FIG. 6C. This contact provides the ability to dampen movement in both the fore/aft direction and the lateral direction. FIG. 6C shows the tailgate 18 at a location that 3 mm from a fully closed position. The tailgate 18 can then move to the fully closed position (FIG. 5) without having any significant drag along the bumper surface while closing.

Thus, in implementations, the first bumper 52 and the second bumper 54 are separate from each other and independently compressible from each other to provide multi-directional damping. As such, rotation of the assembly in one direction increases forces in another direction for damping.

In implementations, the bidirectional reactive bumper assembly 24 is assembled as described below. In one example, the bumpers 52, 54 are overmolded or assembled onto the arms 44, 46. The bushings 68 are positioned in the arm 32 and base 30 subsystems. The arm subsystem 32 is aligned to the base subsystem 30 and is then rotated into a tailgate open orientation. The upper pivot 62 is inserted through an opening on the bottom of the base and through the bore 70 of the shaft body 50 and press fit into the upper pivot mount arm of the base plate 36. The resilient member 66 is inserted such that one bent arm end of the resilient member 66 is coupled to the forked portion 72 of the upper pivot 62. The lower pivot 64 is then inserted and press fit into the lower section of the bore 70 of the shaft body such that the opposite bent arm end of the resilient member 66 is coupled to the forked end 72 of the lower pivot 64.

In implementations, a method of operation may include pivotally attaching the bumper assembly 24 to the vehicle box structure 22, and independently compressing the first bumper 52 on the first arm 44 from the second bumper 54 on the second arm 46 in response to input loads from the first tailgate surface 26 and the second tailgate surface 28 that are orientated transversely relative to each other.

During operation, a tailgate may experience significant chucking loads, e.g., forward loads, lateral loads, and a combination of both types of loading. The disclosed unique bumper system accommodates tailgate chucking motion, in any direction, to quickly and effectively damp movement. For example, as the tailgate 18 moves forward, the arms 44, 46 and bumper pads 52, 54 rotate and increase the lateral force on side surface 28 of the tailgate 18. Also, for example, as the tailgate 18 moves laterally, the arms 44, 46 and bumper pads 52, 54 rotate and increase the force on a forward facing surface 26 of the tailgate 18. Thus, the bumper system is adaptable based on a vehicle’s specific directional loading, and can accommodate configurations where a tailgate on a particular vehicle experiences higher loading in one direction than another.

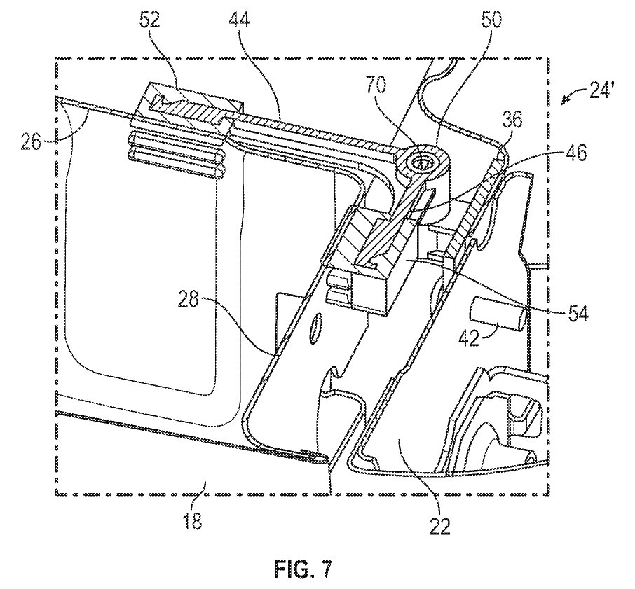

FIG. 7 shows another example of a bumper arm assembly 24’. In implementations, this configuration is similar to bumper assembly 24 as described above but in this configuration one arm of the bumper system is longer than the other to act as a force multiplier. This provides for tuning of the bumper assembly 24’ for vehicle configurations where lateral loads are greater than fore/aft loads or vice versa. Thus, if lateral loads are higher than fore/aft loads, the lateral length of the first arm 44 can be increased to increase the applied force. FIG. 7 shows an example where the first arm 44 has a greater length than the second arm 46.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a first arm including a pivotal attachment interface associated with a vehicle box structure;
a second arm coupled to the first arm;
a first bumper associated with the first arm, the first bumper comprising a first tailgate abutment surface; and
a second bumper associated with the second arm, the second bumper comprising a second tailgate abutment surface.

2. The assembly of claim 1, including a base with a box attachment interface, the first arm and the second arm being pivotally attached to the base via the pivotal attachment interface.

3. The assembly of claim 1, wherein the first arm and the second arm rotate as unit about a center axis defined by the pivotal attachment interface.

4. The assembly of claim 3, wherein the unit is in a first position when a tailgate associated with the vehicle box structure is in an open position and wherein the unit is in a second position when the tailgate is in a closed position, and including at least one resilient member that biases the unit toward the first position.

5. The assembly of claim 1, wherein the first tailgate abutment surface is engageable with a forward facing tailgate surface and the second tailgate abutment surface is engageable with a side facing tailgate surface when in a tailgate closed position.

6. The assembly of claim 1, wherein the first bumper and the second bumper are separate from each other and independently compressible from each other.

7. The assembly of claim 1, wherein one of the first arm and the second arm is longer than the other of the first arm and the second arm.

8. An apparatus comprising:
a vehicle box structure;
a tailgate moveable relative to the vehicle box structure between an open position and a closed position, wherein the tailgate includes a first surface and a second surface that extends transversely relative to the first surface; and
at least one bumper assembly comprising:
a first arm coupled to a second arm via a pivotal attachment interface, wherein the pivotal attachment interface is associated with the vehicle box structure;
a first bumper associated with the first arm, the first bumper engageable with the first surface; and
a second bumper associated with the second arm, the second bumper engageable with the second surface.

9. The apparatus of claim 8, including a base plate with an attachment interface to attach to the vehicle box structure and including a pair of pivot mount arms that interface with the pivotal attachment interface.

10. The apparatus of claim 8, wherein the first arm and the second arm rotate as unit about a center axis defined by the pivotal attachment interface.

11. The apparatus of claim 8, wherein the at least one bumper assembly includes at least one resilient member that biases the first arm and the second arm toward the open position.

12. The apparatus of claim 8, wherein the first surface of the tailgate comprises a forward facing tailgate surface and the second surface of the tailgate comprises an edge surface when in the closed position.

13. The apparatus of claim 12, wherein the first bumper and the second bumper are separate from each other and independently compressible from each other in response to input loads from the forward facing tailgate surface and the edge surface.

14. The apparatus of claim 8, wherein the first arm extends in a lateral direction along a vehicle width and the second arm extends in a longitudinal direction along a vehicle length when in the closed position.

15. The apparatus of claim 8, wherein one of the first arm and the second arm is longer than the other of the first arm and the second arm.

16. The apparatus of claim 8, wherein outward facing surfaces of the first bumper and the second bumper includes a plurality of discrete ribs.

17. A method comprising:
pivotally attaching a bumper assembly to a vehicle box structure, the bumper assembly comprising a first bumper arm coupled to a second bumper arm; and
independently compressing a first bumper on the first bumper arm from a second bumper on the second bumper arm in response to input loads from a first tailgate surface and a second tailgate surface different from the first tailgate surface.

18. The method of claim 17, including mounting a tailgate for pivotal movement relative to the vehicle box structure between an open position and a closed position, and wherein the first tailgate surface comprises a forward facing tailgate surface and the second tailgate surface comprises an edge tailgate surface when in the closed position.

19. The method of claim 18, wherein the bumper assembly is in a first position when the tailgate is in the open position and is in a second position when the tailgate is in the closed position, and including biasing the bumper assembly toward the first position.

20. The method of claim 17, wherein a shaft connects the first bumper arm and the second bumper arm together, and including pivoting the first bumper arm and the second bumper arm together as a unit about a pivot axis defined by the shaft.
